(19) United States
(12) Patent Application Publication
(10) Pub. No.: US 2017/0317960 A1
(43) Pub. Date: Nov. 2, 2017

(54) DEVICE AND METHODS FOR MESSAGING APPLICATION CONTROL AND PRESENTATION

(71) Applicants: Jamdeo Canada Ltd., Oakville (CA); Hisense Electric Co., Ltd., Qingdao (CA); Hisense USA CORP., Suwanee, GA (US); Hisense International Co., Ltd., Qingdao (CN)

(72) Inventors: Sanjiv SIRPAL, Oakville (CA); Saulo DOURADO, Oakville (CA)

(73) Assignees: Jamdeo Canada Ltd., Oakville (CA); Hisense Electric Co., Ltd., Qingdao (CA); Hisense USA CORP., Suwanee, GA (US); Hisense International Co., Ltd., Qingdao (CN)

(21) Appl. No.: 15/141,470

(22) Filed: Apr. 28, 2016

(51) Int. Cl. H04L 12/58; G06F 3/0481; G06F 3/0484

(52) U.S. Cl. CPC H04L 51/24; H04L 51/34; H04L 51/10; G06F 3/0481; G06F 3/04842; H04L 51/06

(57) ABSTRACT

The present disclosure relates to methods and devices for detecting control commands and present display notifications. In one embodiment, the method includes displaying a user interface for a message application, wherein the user interface is displayed to include a display window configured for graphical representation of received and transmitted messages for a communication session with an active contact, and a contact display element configured for presentation of one or more contact graphical elements. The method also includes detecting, by the device, a message from a second contact and updating, by the device, presentation of the user interface, wherein a contact graphical element associated with the second contact and associated with the contact display element is displayed including a graphical element identifying a number of unread messages received from the second contact.

### CROSS-REFERENCE TO RELATED APPLICATIONS

This application claims priority to U.S. Provisional Application No. 62/183,613 titled SYSTEM AND METHODS FOR A USER INTERFACE AND DEVICE OPERATION filed on Jun. 23, 2015, and U.S. Provisional Application No. 62/184,476 titled SYSTEM AND METHODS FOR A USER INTERFACE AND DEVICE OPERATION filed on Jun. 25, 2015, the content of which is expressly incorporated by reference in its entirety.

### FIELD

The present disclosure relates to operation of an electronic device for communication, and more particularly to methods and devices configured for presenting notifications by a device associated with a messaging application.

### BACKGROUND

Electronic devices and can operate with few or many functionalities. Control commands for devices are usually tied to functionality of the device. Improving control of a device can improve the experience of using a device. In addition, improving control can reduce the time required to operate a device by minimizing the number of control commands required to access information or perform a one or more actions. Improving control can also allow for added functionality that may not be available without particular control configurations. In many cases, conventional devices are configured to require particular steps to access functionality, such as obtain message data. These conventional messages are typically designed for a single communication session between a user of the device and another network end-user. Accordingly, conventional user interfaces are limited in their functionality and controllability with respect to communication sessions and in particular to multiple communications sessions. There exists a need to overcome message presentation and access to device control features and overall controllability of devices.

### BRIEF SUMMARY OF THE EMBODIMENTS

Disclosed and claimed herein are methods and devices for operation to detect control commands and present display notifications. One embodiment is directed to a method including displaying, by a device, a user interface for a message application, wherein the user interface is displayed to include a display window configured for graphical representation of received and transmitted messages for a communication session with an active contact, and a contact display element configured for presentation of one or more contact graphical elements. The method also includes detecting, by the device, a message from a second contact and updating, by the device, presentation of the user interface, wherein a contact graphical element associated with the second contact and associated with the contact display element is displayed including a graphical element identifying a number of unread messages received from the second contact.

In one embodiment, the display window is configured to include graphical representation of at least one of image and text associated with a messaging session.

In one embodiment, the contact display element includes a plurality of contacts, wherein each contact is displayed with an image and a graphical element identifying a number of unread messages.

In one embodiment, the contact display element is updated by the controller based on at least one of receiving a message and order that communication sessions were initiated.

In one embodiment, messages are detected by a controller of the device configured according to a mobile device communication protocol.

In one embodiment, updating presentation of the user interface includes changing the number of unread messages for a contact in the contact display element.

In one embodiment, updating presentation of the user interface includes presenting a drop down text display from the contact display element including a preview of content associated with the message from the second contact.

In one embodiment, the method also includes detecting selection of the contact display element and presenting a conversation window based on the selection.

In one embodiment, the method also includes decoding the received message and updating presentation order of the contact display element.

In one embodiment, the method also includes updating the content display element to present data associated with network content.

Another embodiment is directed to a device including a display and a controller coupled to the memory, the configured to present a content player and run a content buffer to display a user interface for a message application, wherein the user interface is displayed to include a display window configured for graphical representation of received and transmitted messages for a communication session with an active contact, and a contact display element configured for presentation of one or more contact graphical elements. The controller is also configured to detect a message from a second contact and update presentation of the user interface, wherein a contact graphical element associated with the second contact and associated with the contact display element is displayed including a graphical element identifying a number of unread messages received from the second contact.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of device operation according to one or more embodiments;

FIG. 2 depicts a process for device operation according to one or more embodiments;

FIG. 3 depicts a simplified diagram of a device according to one or more embodiments;

FIG. 4 depicts a process for detecting control commands and presenting display notifications according to one or more embodiments;

FIG. 5 depicts a graphical representation of device operation according to one or more embodiments;

FIG. 6 depicts a graphical representation of device operation according to one or more embodiments; and

FIG. 7 depicts a graphical representation of device operation according to one or more embodiments.

### DETAILED DESCRIPTION OF THE EXEMPLARY EMBODIMENTS

### Overview and Terminology

One aspect of the disclosure is directed to operation of a device for use in communication, and in particular electrical messaging between electronic devices including a display configured to present a user interface. According to one embodiment, a device, system and methods are provided for presenting notifications by a device associated with a messaging application. According to another embodiment, configurations are provide to process incoming communications, present notifications by a display and provide a control interface associated with the notifications. As such, configurations and methods provided herein can overcome the need for hard buttons, improve operation of a device and solve problems associated with electronic communication by way of an electronic device. Embodiments discussed herein can also improve communication sessions, such as multiple sessions with different users, based on the configuration and operation of a device.

In one embodiment, device operation includes presentation of a user interface or display window including a display window configured for graphical representation of received and transmitted messages for a communication session with an active contact, and a contact display element configured for presentation of one or more contact graphical elements. The presentation is configured to allow for a communication session between a user of a device and an active contact and allow for notifications from other contacts associated with the messaging application.

As used herein, messaging relates to multimedia messaging services associated with electrical communications such as phone, network (e.g., internet, etc.) and mobile communication systems. Messaging can include transmission of at least one of text, image, audio, video and data. A session relates to communication between a user of a device and one or more contacts. A message application relates to computer-implemented process performed by a device, such as a personal communication device or electronic device configured to provide messaging service either as an add-on implementation or integrated with core operating system of the device.

As used herein, a contact relates to a network identity that can send and/or receive messages to the device. In one embodiment, contacts are associated with data stored by a user for the device. In other embodiments, contacts relate to network entities configured to communicate via the network, wherein contact information is not necessarily stored to the device.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### EXEMPLARY EMBODIMENTS

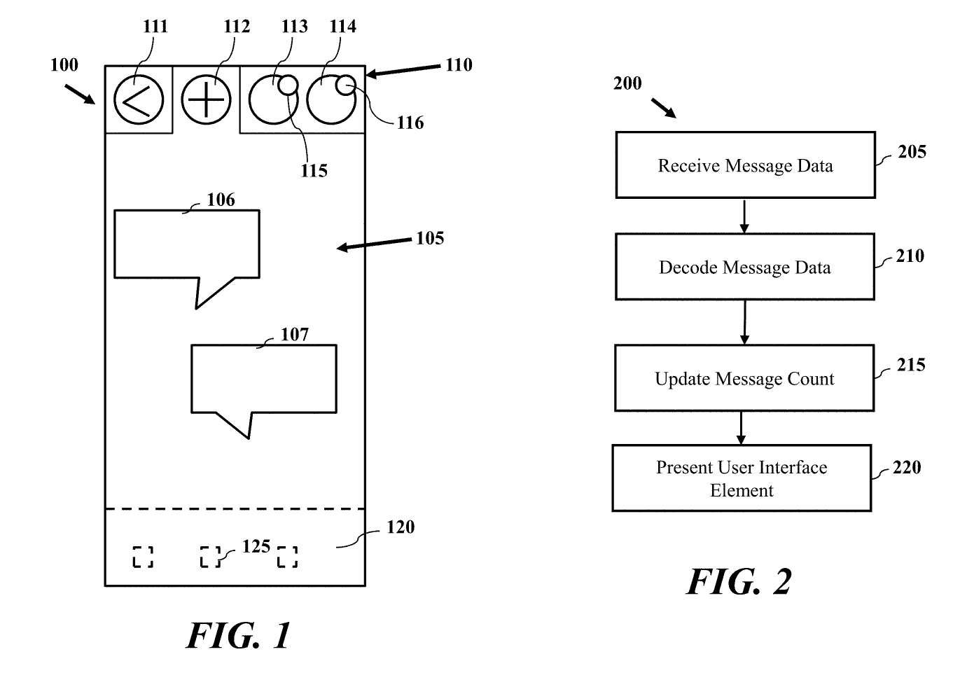

Referring now to the figures, FIG. 1 depicts a graphical representation of device operation according to one or more embodiments. According to one embodiment, a device is configured to present user interface 100 including display window 105 and contact display element 110. User interface 100 is presented for a messaging application according to one or more embodiments. According to one embodiment, user interface 100 is a touch-sensitive user interface associated with a touch screen display of a device. Display window 105 is configured to present messages, such as message 106 and message 107, associated with a user of the device and a contact associated with the communication session. Each communication session presented by display window 105 may be associated with a communication session or dialogue between the user of the device and one or more additional network entities. Network entities stored on the device, or recognized by the device are contacts. By way of example, message 106 may relate to a message received by the device and message 107 may relate to a message transmitted by the device. In that fashion, display window 105 graphical presents a dialogue/conversation of the communication session.

According to one embodiment, user interface 100 includes contact display element 110. In one embodiment, contact display element 110 is a navigation bar for selecting one or more contacts. As shown in FIG. 1, contact display element 110 includes a plurality of graphical elements. Back element 111 may be selected to exit the messaging application. Element 112 represents the current conversation. In certain embodiments, element 112 may be selected to add or remove contacts from the conversation in display window 105. In other embodiments, element 112 may be selected to receive additional information from a contact associated with the conversation. According to one or more embodiments, contact display element 110 is presented to provide quick access to conversations and notify the number of messages from the conversations. As such, contact display element 110 eliminates the need for multiple user inputs to view other conversations and provides functionality that improves the operation of a device. In one embodiment, contact display element 110 is configured to provide inline notifications of messages from conversations.

According to another embodiment, contact display element 110 includes the display of one or more graphical elements for contacts not associated with the current conversation in display window 105. As such, user interface 105 can allow for notification of one or more additional messages received by a device. In addition, contact display element 110 can allow for presentation of information to allow the user to determine whether to select another conversation. In that fashion, the problem of having to exit a conversation and switch to another conversation is solved. By way of example, contact display element 110 provides graphical elements indicating recent messages, and allows for selecting another contact to provide fast switching between conversations or communication sessions.

According to one embodiment, contact display element 110 is displayed as a top bar across the top portion of a display window and includes graphical elements 113 and 114 associated with a different contact (e.g., contact not part of the current conversation in display window 105). Presentation of contacts by graphical elements 113 and 114 can include presentation of graphical elements 115 and 116 to notify the number of unread messages for each contact. By way of example, during a conversation with a first contact represented by element 112 and presented in display window 105, an incoming message may be detected by the device. Based on detection of the message, the device may add a graphical element for the second contact, such as graphical elements 113 to contact display element 110 and present update the number of unread messages available for the second contact with graphical element 115. Thus, when one or more messages are received during a communication session from contacts not associated with the current session, the user interface can present a graphical element identifying the contact (e.g., graphical element 113, 114) and the number of messages. As will be discussed in more detail below, the contact display element 110 can also be updated following receipt of a message to provide a preview of the received message. According to another embodiment, a device is configured to present contact display element 110 as a bar for one or more other applications, such that a user of the device can be notified of incoming messages without the device having to present a conversation dialogue in display window 105.

Presentation of content element bar can optimize layout areas for large screen devices, such as phones and personal communications devices. According to one embodiment, the presentation of content display element 110 may be applied to messaging applications and core applications of a device. According to another embodiment, the location of content display element 110 can be presented as a top bar, bottom bar, side bar, widget, etc.

According to another embodiment, user interface 100 can optionally include interface 120 including optional control elements 125 which may be displayed elements or physical elements of the device that can be selected. Optional control elements 125 can be presented with user interface 100 according to one or more embodiments.

Presentation and interaction with content display element 110 allows for a device to provide control functionality for the ability to quickly change between simultaneously occurring sessions. Another advantage is the ability to present a preview of received data during a current conversation session.

FIG. 2 depicts a process for device operation according to one or more embodiments. According to one embodiment, process 200 is executed by a controller of a device to present a message application user interface (e.g., user interface 100). Process 200 can be initiated by receiving message data at block 205. According to one embodiment, a device can receive message data during presentation of a user interface for a messaging application and during periods where the messaging application is not displayed.

At block 210, message data is decoded to identify the sender of the message and content of the message. Identification of the sender can be employed to match the sender to one or more contacts recognized by the device, such as stored contacts including a telephone number, contact name, contact details, etc. Decoding the message data can be performed by a communications module of a device, which may be a portion of the device controller, to allow the device to present a message application and/or message application functionality.

At block 215, the device can update a message count for the sender, and in particular a contact of the device. Contacts not recognized (i.e., previously stored, previously programmed, etc.) can be presented as a contact identified by the telephone number or contact details for the sender. Updating message count can include aggregating the number of unread messages for the contact and presenting a graphical element indicating the number of unread messages in the user interface, such as within a contact display element. According to one embodiment, updating the message count provides a display notification of unread messages for a contact without requiring the user to navigate away from an existing conversation window and allows for additional information to be presented to the user.

At block 220, process 200 includes presenting a user interface element. The user interface element can include a graphical element or elements indicating a numerical value for unread messages associated with a contact and may be displayed within a contact display element. Presentation of the user interface element can include additional graphical elements or treatments, such as a dropdown display from a contact bar including a preview of message content. According to another embodiment, presentation of the notification includes presentation of a selectable element that allows for the device to switch display of the user interface to present messages associated with the selected contact. According to another embodiment, presenting a user interface element includes determining which contacts to present in the contact display element. In certain embodiments, only contacts for which unread messages are associated with will be displayed. According to another embodiment, a device determines which contact elements to include in the contact display element based on the number of unread messages, user communication with contacts that have sent unread messages and one or more additional factors.

Process 200 may also include detecting user selection of a present user interface element to control the presentation of a user interface of the device. In that fashion, the presented user interface can provide information and act as a control source for a device.

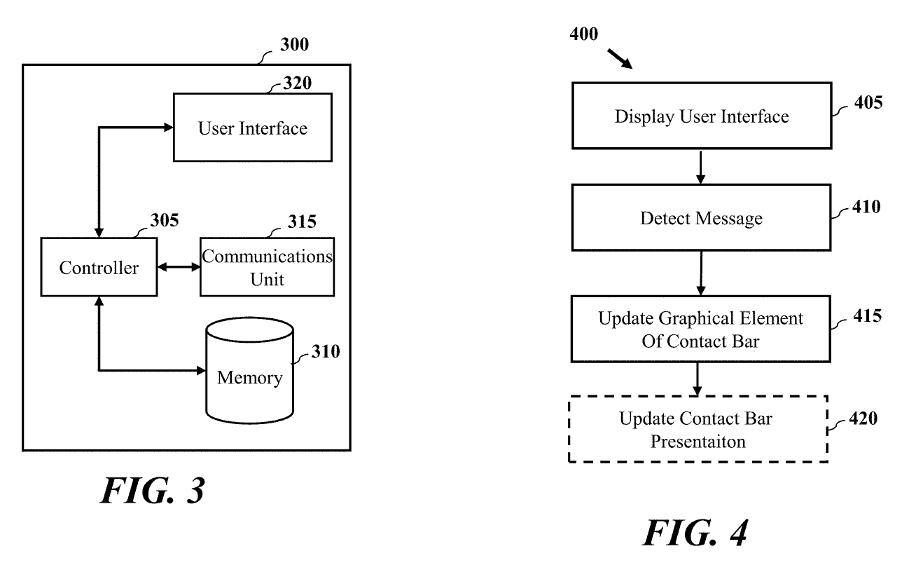

FIG. 3 depicts a simplified diagram of a device according to one or more embodiments. Device 300 may relate to one or more devices configured for communication and in particular, transmission and receiving of messages such as multimedia messages, text messages and network messages. In certain embodiments, device 300 is a standalone device configured for multiple functions including communication.

As shown in FIG. 3, device 300 includes controller 305, memory 310, communications unit 315 and user interface 320. Controller 305 may be configured to execute code stored in memory 310 for operation of device 300 including presentation of a messaging application and content display element. According to one embodiment, controller 305 includes a processor and/or one or more processing elements. In one embodiment, controller 305 includes one or more of hardware, software, firmware and/or processing components in general. According to one embodiment, controller 305 is configured to perform one or more processes described herein. Communications unit 315 is configured for wired and/or wireless communication with one or more network elements, such as servers. Memory 310 can include non-transitory RAM and/or ROM memory for storing executable instructions, operating instructions and content for display. User interface 320 can include one or more input/output interfaces for control and/or communication. In one embodiment, user interface 320 includes a touch-sensitive user interface and touch screen display. In certain embodiments, device 300 relates to a personal communication device including a display as part of user interface 320.

FIG. 4 depicts a process for device operation according to one or more embodiments. According to one embodiment, process 400 is executed by a controller of a device to update a message application user interface (e.g., user interface 100). Process 400 can be initiated by displaying a user interface at block 405. According to one embodiment, the user interface is for a messaging application and is displayed to include a display window and a contact display element. The display window is configured to include graphical representation of at least one of image and text associated with a messaging session. According to one embodiment, the contact display element includes a plurality of contacts, wherein each contact is displayed with an image and a graphical element identifying a number of unread messages. The contact display element is updated by the controller based on at least one of receiving a message and order that communication sessions were initiated. In one embodiment, the display window is configured for graphical representation of received and transmitted messages for a communication session with an active contact. According to another embodiment, a contact display element is configured for presentation of one or more contact graphical elements.

At block 410, a message is detected by the device, such as a message from a second contact. Messages can be detected by a controller of the device configured according to a mobile device communication protocol.

At block 415, the device updates presentation of the user interface, wherein a contact graphical element associated with the second contact and associated with the contact display element is displayed including a graphical element identifying a number of unread messages received from the second contact. Updating presentation of the user interface includes changing the number of unread messages for a contact in the contact display element.

At block 420, process 400 can optionally update contact bar presentation. Updating presentation of the user interface includes presenting a drop down text display from the contact display element including a preview of content associated with the message from the second contact.

Process 400 may also include optionally updating the contact display element (e.g., contact bar at block 420 based on detected messages, user selections of the contact element, and/or duration of time with respect to displayed contacts. In one embodiment, detected selections of the contact display element prompt the controller to present a conversation window based on the selection. According to another embodiment, the controller can decode the received message and update presentation order of the contact display element. In certain embodiments, the controller can update the content display element to present data associated with network content.

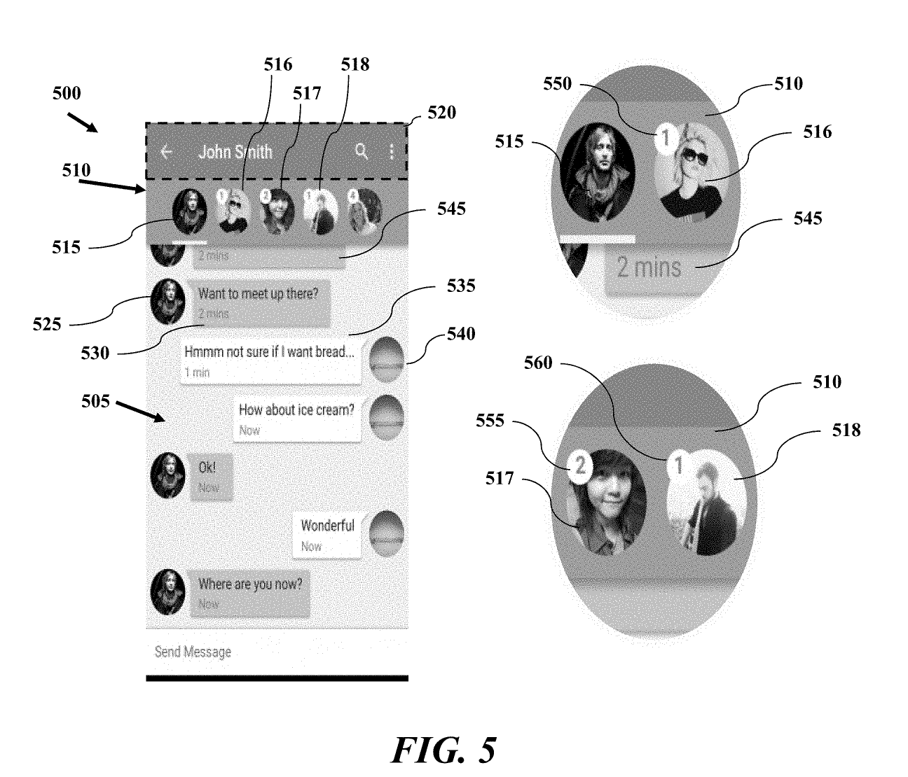

FIG. 5 depicts a graphical representation of device operation according to one or more embodiments. According to one embodiment, device (e.g., device 300) is configured to present user interface 500 including display window 505 and contact display element 510. User interface 500 is presented for a messaging application according to one or more embodiments. According to one embodiment, display window 505 is configured to present messages, such as message 530 and message 535, associated with a user of the device and a contact 515 associated with the communication session.

According to one embodiment, user interface 500 includes contact display element 510 including one or more graphical element (e.g., images, text, designs, etc.). In one embodiment, contact display element 510 is a navigation bar for selecting one or more contacts 516, 517 and 518 for example. User interface 500 may also include optional display area 520 including a name of contact 515 and one or more device controls.

As shown in FIG. 5, display window 510 includes messages 530 for contact 515 and image 525 representing the contact 515 in display window 505. In addition, display window 505 includes message 535 and an image 540 associated with an operator for the device.

According to one embodiment, in response to a device detecting an incoming message, user interface 500 can include updating a graphical element of contact display element 510. By way of example, a message received from contact 516 may be decoded and graphical element 550 may be displayed by the device. In addition, a time identifier 545 may be display as a temporary drop down from display element 510.

According to another embodiment content display element 510 may include multiple notifications, such as graphical element 555 for contact 517 and graphical element 560 for contact 518, each of the graphical elements indicating the number of unread messages.

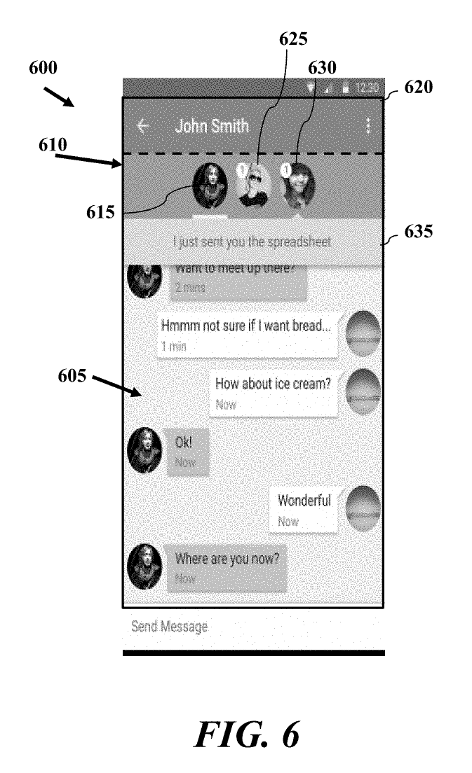

FIG. 6 depicts a graphical representation of device operation according to one or more embodiments. According to one embodiment, a device (e.g., device 300) is configured to update a user interface 600 based on message content received while a user is active in a different message session. User interface 600 is presented including display window 605 and contact display element 610. User interface 600 is presented for a messaging application according to one or more embodiments. According to one embodiment, display window 605 is configured to present messages.

According to one embodiment, user interface 600 includes contact display element 610 including one or more graphical element for contacts 625, 630. According to one embodiment, based on a detected message and in addition to the number of unread messages displayed associated with a contact image, the device may be configured to present a drop down message preview 635 which can relate to temporary display of decoded message text while a message conversation is occurring.

As shown in FIG. 6, display window 610 includes messages 630 for contact 616 and image 626 representing the contact 616 in display window 606. In addition, display window 606 includes message 636 and an image 640 associated with an operator for the device.

According to one embodiment, in response to a device detecting an incoming message, user interface 600 can include updating a graphical element of contact display element 610. By way of example, a message received from contact 616 may be decoded and graphical element 660 may be displayed by the device. In addition, a time identifier 646 may be display as a temporary drop down from display element 610.

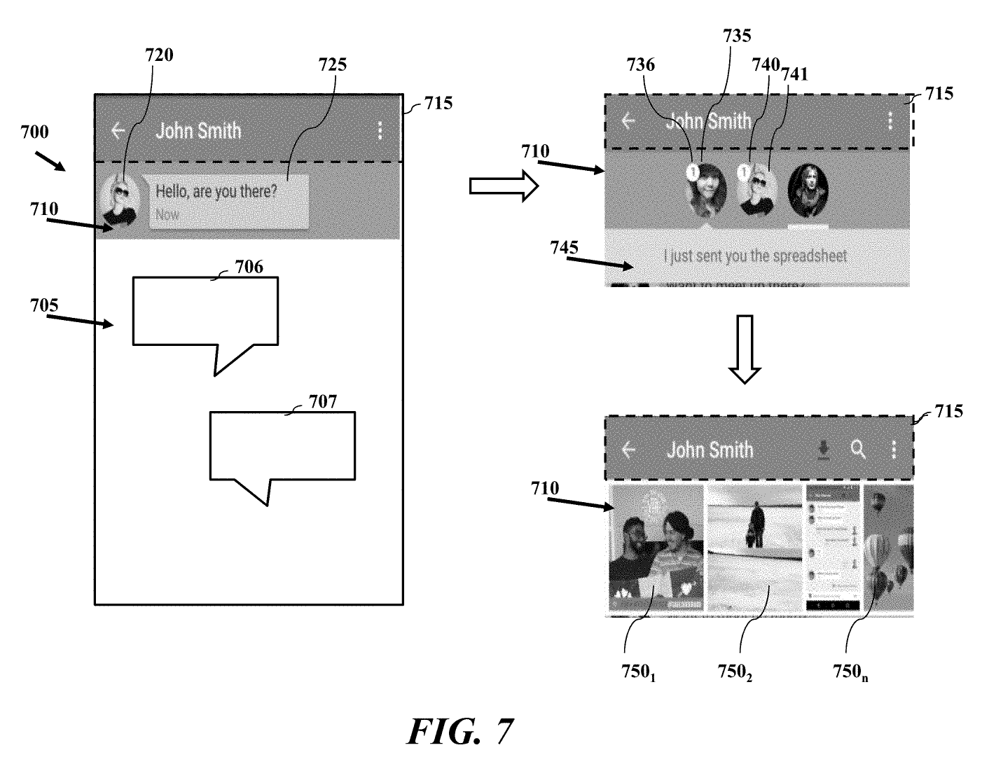

FIG. 7 depicts a graphical representation of device operation according to one or more embodiments. According to one embodiment, a device (e.g., device 300) is configured to update a user interface 700 based on message content received while a user is active in a different message session and/or one or more user inputs. User interface 700 is presented including display window 705 and contact display element 710. User interface 700 is presented for a messaging application according to one or more embodiments. According to one embodiment, display window &05 is configured to present messages, such as message 706 and message 707.

According to one embodiment, user interface 700 includes contact display element 710 configured to present a graphical element identifying a contact, such as contact 720 and a preview of an incoming unread message 725 in the content 710 display element.

FIG. 7 depicts content display element 710 transitioning to display additional contacts such as contact 735, contact 741 based on received message content. As shown in FIG. 7, element 736 and element 740 are presented to identify a number of unread messages received from the contact. In addition, once additional contacts are presented in the contact display element 710, drop down message 745 is presented to identify an incoming message.

FIG. 7 also depicts presentation of a series of images within the content display element which can relate to previously received image data and/or data from a users network account.

While this disclosure has been particularly shown and described with references to exemplary embodiments thereof, it will be understood by those skilled in the art that various changes in form and details may be made therein without departing from the scope of the claimed embodiments.

What is claimed is:

1. A method for device operation to detect control commands and present display notifications, the method comprising:
displaying, by a device, a user interface for a message application, wherein the user interface is displayed to include
a display window configured for graphical representation of received and transmitted messages for a communication session with an active contact, and
a contact display element configured for presentation of one or more contact graphical elements;
detecting, by the device, a message from a second contact; and
updating, by the device, presentation of the user interface, wherein a contact graphical element associated with the second contact and associated with the contact display element is displayed including a graphical element identifying a number of unread messages received from the second contact.

2. The method of claim 1, wherein the display window is configured to include graphical representation of at least one of image and text associated with a messaging session.

3. The method of claim 1, wherein the contact display element includes a plurality of contacts, wherein each contact is displayed with an image and a graphical element identifying a number of unread messages.

4. The method of claim 1, wherein the contact display element is updated by the controller based on at least one of receiving a message and order that communication sessions were initiated.

5. The method of claim 1, wherein messages are detected by a controller of the device configured according to a mobile device communication protocol.

6. The method of claim 1, wherein updating presentation of the user interface includes changing the number of unread messages for a contact in the contact display element.

7. The method of claim 1, wherein updating presentation of the user interface includes presenting a drop down text display from the contact display element including a preview of content associated with the message from the second contact.

8. The method of claim 1, further comprising detecting selection of the contact display element and presenting a conversation window based on the selection.

9. The method of claim 1, further comprising decoding the received message and updating presentation order of the contact display element.

10. The method of claim 1, further comprising updating the content display element to present data associated with network content.

11. A device comprising:
a display; and
a controller coupled to the display, the controller configured to
display a user interface for a message application, wherein the user interface is displayed to include
a display window configured for graphical representation of received and transmitted messages for a communication session with an active contact, and
a contact display element configured for presentation of one or more contact graphical elements;
detect a message from a second contact; and
update presentation of the user interface, wherein a contact graphical element associated with the second contact and associated with the contact display element is displayed including a graphical element identifying a number of unread messages received from the second contact.

12. The device of claim 1, wherein the display window is configured to include graphical representation of at least one of image and text associated with a messaging session.

13. The device of claim 1, wherein the contact display element includes a plurality of contacts, wherein each contact is displayed with an image and a graphical element identifying a number of unread messages.

14. The device of claim 1, wherein the contact display element is updated by the controller based on at least one of receiving a message and order that communication sessions were initiated.

15. The device of claim 1, wherein messages are detected by a controller of the device configured according to a mobile device communication protocol.

16. The device of claim 1, wherein updating presentation of the user interface includes changing the number of unread messages for a contact in the contact display element.

17. The device of claim 1, wherein updating presentation of the user interface includes presenting a drop down text display from the contact display element including a preview of content associated with the message from the second contact.

18. The device of claim 1, further comprising detecting selection of the contact display element and presenting a conversation window based on the selection.

19. The device of claim 1, further comprising decoding the received message and updating presentation order of the contact display element.

20. The device of claim 1, further comprising updating the content display element to present data associated with network content.
